(19) United States
(12) Patent Application Publication
(10) Pub. No.: US 2014/0102477 A1
(43) Pub. Date: Apr. 17, 2014

(54) CLEANING APPARATUS

(71) Applicant: Kevin T. Grandey, Westerville, OH (US)

(72) Inventor: Kevin T. Grandey, Westerville, OH (US)

(73) Assignee: ABBOTT LABORATORIES, ABBOTT PARK, IL (US)

(21) Appl. No.: 14/124,105

(22) PCT Filed: Jun. 8, 2012
(86) PCT No.: PCT/US12/41506

§ 371 Date: Dec. 5, 2013

Related U.S. Application Data
(60) Provisional application No. 61/495,469, filed on Jun. 10, 2011.

(51) Int. Cl. B08B 9/087; B08B 9/42

(52) U.S. Cl. CPC B08B 9/087; B08B 9/42
USPC 134/6; 15/97.1

(57) ABSTRACT

An apparatus for cleaning an article includes a drive belt and a wiper belt. The drive belt defines a first article engaging surface substantially parallel to a second article engaging surface of the apparatus and positioned to receive the article between the first and second article engaging surfaces. The drive belt is powered to move in a first direction such that the first article engaging surface imparts a forward motive force on a side wall of the article. The wiper belt defines an article wiping surface positioned to contact the article, the wiper belt being powered to move in a second direction opposite the first direction such that the first article wiping surface imparts a rearward wiping force on the article.

### CROSS-REFERENCE TO RELATED APPLICATION

The present application claims priority from U.S. Provisional Application Ser. No. 61/495,469 entitled “CONTAINER CLEANING APPARATUS,” filed on Jun. 10, 2011, the entire disclosure of which is fully incorporated herein by reference.

### BACKGROUND

Automated container filling systems, such as, for example, those used to fill containers with powdered products (e.g., infant formula), often generate and/or are exposed to dirt, debris, product residue, and other contaminants that can adhere to the outer surfaces of the container. These contaminants may affect adhesion of labels to the containers, and may affect product cleanliness. Known methods for removing such contaminants include the application of pressurized air or vacuum suction, or the placement of bristle brushes along the conveyor line to brush contaminants from a container as the container is conveyed through the system.

### SUMMARY

The present application discloses exemplary embodiments of apparatuses, systems, and methods for cleaning an article, such as, for example, a container. In one embodiment, a cleaning apparatus includes a drive member that is powered to impart a forward motive force on the article and a wiper member that is powered to impart a wiping force on the article.

Accordingly, in an exemplary embodiment, an apparatus for cleaning an article includes a drive belt and a wiper belt. The drive belt defines a first article engaging surface substantially parallel to a second article engaging surface of the apparatus and positioned to receive the article between the first and second article engaging surfaces. The drive belt is powered to move in a first direction such that the first article engaging surface imparts a forward motive force on a side wall of the article. The wiper belt defines an article wiping surface positioned to contact the article, the wiper belt being powered to move in a second direction opposite the first direction such that the first article wiping surface imparts a rearward wiping force on the article.

In another exemplary embodiment, an apparatus for cleaning an article includes a means for imparting a forward motive force on the article and a wiper belt. The wiper belt defines an article wiping surface and includes a plurality of flexible projections formed with the first wiper belt as an integral elastomeric component. The plurality of flexible projections are sized and positioned to impart a wiping force on the article when the wiper belt is moved with respect to the article.

In an exemplary method of cleaning an article, an article is received between first and second opposed article engaging surfaces. At least the first article engaging surface is moved to impart a forward motive force on a side wall of the article. The article is contacted with a first article wiping surface disposed on a first wiper belt. The first wiper belt is moved such that the first article wiping surface imparts a rearward wiping force on the article.

### BRIEF DESCRIPTION OF THE DRAWINGS

Further features and advantages will become apparent to those of ordinary skill in the art to which the invention pertains from a reading of the following description together with the accompanying drawings, in which:

FIG. 1 illustrates a schematic view of a cleaning apparatus, according to an exemplary embodiment;

FIG. 2 illustrates a schematic view of another cleaning apparatus, according to an exemplary embodiment;

FIG. 3 illustrates a schematic view of still another cleaning apparatus, according to an exemplary embodiment;

FIG. 4 illustrates a front perspective view of a cleaning apparatus, according to an exemplary embodiment;

FIG. 5 illustrates a rear perspective view of the cleaning apparatus of FIG. 4;

FIG. 6 illustrates a front perspective view of the cleaning apparatus of FIG. 4, with the support frame and cover assemblies removed to illustrate additional features of the cleaning apparatus;

FIG. 7 illustrates a rear perspective view of the cleaning apparatus of FIG. 4, with the support frame and cover assemblies removed to illustrate additional features of the cleaning apparatus;

FIG. 8 illustrates an upper perspective view of the cleaning apparatus of FIG. 4, with the support frame and cover assemblies removed to illustrate additional features of the cleaning apparatus;

FIG. 9 illustrates a perspective view of the first side assembly of the cleaning apparatus of FIG. 4, with the cover assembly removed to illustrate additional features of the cleaning apparatus;

FIG. 10 illustrates a perspective view of the second side assembly of the cleaning apparatus of FIG. 4, with the cover assembly removed to illustrate additional features of the cleaning apparatus;

FIG. 11A illustrates a first side perspective view of the lower assembly of the cleaning apparatus of FIG. 4, with the cover plate removed to illustrate additional features of the cleaning apparatus;

FIG. 11B illustrates a second side perspective view of the lower assembly of the cleaning apparatus of FIG. 4;

FIG. 12 illustrates a partial upper perspective view of the first side assembly and first wiper cleaning assembly of the cleaning apparatus of FIG. 4, with the cover assembly and vacuum plenum cover plate removed to illustrate additional features of the cleaning apparatus;

FIG. 13 illustrates a partial upper perspective view of the second side assembly and second wiper cleaning assembly of the cleaning apparatus of FIG. 4, with the cover assembly and vacuum plenum cover plate removed to illustrate additional features of the cleaning apparatus;

FIG. 14 illustrates a partial perspective view of a wiper member, according to an exemplary embodiment;

FIG. 14A illustrates an enlarged partial side view of the wiper member of FIG. 14;

FIG. 15 illustrates a partial perspective view of another wiper member, according to an exemplary embodiment; and

FIG. 15A illustrates an enlarged partial side view of the wiper member of FIG. 15.

### DETAILED DESCRIPTION

This Description merely describes exemplary embodiments and is not intended to limit the scope of the claims in any way. Indeed, the invention as claimed is broader than and unlimited by the exemplary embodiments, and the terms used in the claims have their full ordinary meaning.

As described herein, when one or more components are described as being connected, joined, affixed, coupled, attached, or otherwise interconnected, such interconnection may be direct as between the components (including being integrally formed with each other) or may be indirect such as through the use of one or more intermediary components. Also as described herein, reference to a “member,” “component,” or “portion” shall not be limited to a single structural member, component, or element but can include an assembly of components, members or elements.

According to one aspect of the present application, a cleaning apparatus is provided for cleaning one or more articles conveyed through an automated system (for example, an automated manufacturing, assembly, filling, and/or packaging system). In an exemplary embodiment, a drive member (e.g., a belt, chain, screw auger, rollers) applies a forward motive force to an article to bring the article into contact with an article wiping surface of a wiper member (e.g., a belt, pad, sheet, plate, drum, etc.). The article wiping surface imparts a wiping force on the article to clean the article as the article is conveyed in a forward direction by the drive member.

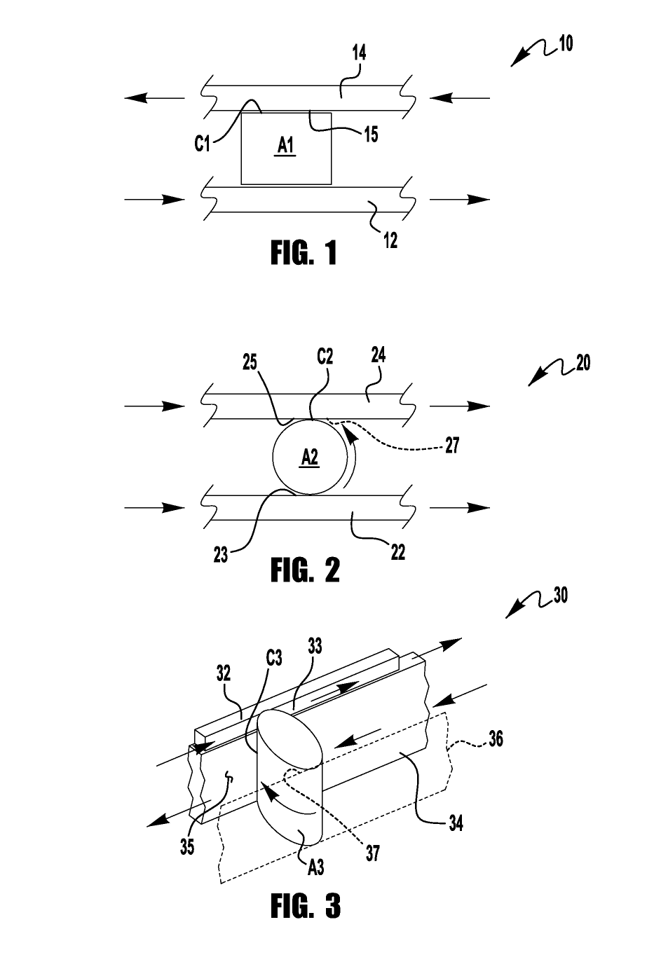

In one such exemplary embodiment, as shown in the schematic illustration of FIG. 1, a cleaning apparatus 10 is provided with a drive member 12 that imparts a forward motive force on an article A1 and a wiper member 14 that is moved such that an article wiping surface 15 imparts a rearward wiping force on a contacted portion C1 of the article A1, opposite or against the forward motive force applied by the drive member 12. This increases the wiping force and cleaning effectiveness on the contacted portion C1 of the article A1.

In another exemplary embodiment, a cleaning apparatus may be configured to rotate an article conveyed through the apparatus, thereby increasing surface contact between the wiper member and the article and/or increasing the wiping force and cleaning effectiveness on the contacted portion of the article. FIG. 2 schematically illustrates an exemplary cleaning apparatus 20 including a drive member 22 having an article engaging surface 23 that imparts a forward rotational force on an article A2. While the article A2 is shown as having a circular profile (e.g., a cylinder or sphere, or an article having a cylindrical or spherical portion), the drive member 22 may be configured to impart rotational forces on articles having different shapes (e.g., square, oval, rectangular, or of irregular shape), for example, by employing a flexible belt or chain to conform to the changing contours of the portion of the article A2 engaged by the drive member 22. An exemplary wiper member 24 is moved such that an article wiping surface 25 imparts a forward wiping force on the contacted portion C2, which is moving relatively rearwardly with respect to the article wiping surface 25.

While the article A2 may remain stationary in the cleaning apparatus 20 during a cleaning operation (e.g., with the drive member only applying a rotational force to the article), the drive member may be configured to apply both a forward rotational force and a forward motive force on the article A2 to facilitate movement of the article A2 through the apparatus while cleaning. This may be facilitated by providing a second article engaging surface 27 opposite the article engaging surface 23 on the drive member 22 and positioned to receive the article A2 therebetween in close fit, contacting, or gripping engagement, such that the article A2 may rotate or roll against the article engaging surfaces 23, 27 in the forward direction.

In another exemplary embodiment, as schematically shown in FIG. 3, a cleaning apparatus 30 may be provided with a drive member 32 and a wiper member 34 disposed on the same side of the article A3, with an article engaging surface 33 of the drive member 32 being substantially coplanar with an article wiping surface 35 of the wiper member 34. The drive member 32 is powered to move such that the article engaging surface 33 imparts one or both of a forward motive force and a forward rotational force on the article A3 (e.g., by moving the article engaging surface 33 in the forward direction). Forward rotation and/or translational movement of the article A3 may be facilitated by providing a second article engaging surface 37 opposite the article engaging surface 33 on the drive member 32 and positioned to receive the article A3 therebetween in close fit, contacting, or gripping engagement, such that the article A3 may rotate or roll against the article engaging surfaces 33, 37 in the forward direction.

The second article engaging surface 37 may be provided on a stationary member (e.g., a plate, rail, pad, etc.) to merely provide close fit, contacting, or gripping engagement between the first and second article engaging surfaces 33, 37 and the article A3. In another exemplary embodiment, the second article engaging surface 37 may be provided on a second drive member 36 (e.g., a belt, chain, screw auger, or rollers) that is powered to apply an additional forward rotational force on the article (e.g., by moving the second article engaging surface 37 in the forward direction). In one such example, the second article engaging surface 37 is moved in the forward direction at a slower rate than the first article engaging surface 33 is moved in the forward direction, such that a net forward rotational force is imparted on the article A3 by the first and second article engaging surfaces 33, 37. In still another exemplary embodiment, the second article engaging surface may be provided on a second drive member that is powered to apply an additional forward rotational force on the article (e.g., by moving the second article engaging surface 37 in the rearward direction). In one such example, the second article engaging surface 37 is moved in the rearward direction at a slower rate than the first article engaging surface 33 is moved in the forward direction, such that a net forward motive force is imparted on the article A3 by the first and second article engaging surfaces 33, 37.

While the wiper member may be a stationary component, in the illustrated example, the wiper member 34 is powered to move such that the article wiping surface 35 imparts a rearward wiping force on the contacted portion C3 of the article A3, against the forward rotational and/or forward translational movement of the article A3. To effect such rearward movement of the article wiping surface 35, the wiper member 34 may include any suitable configuration, including, for example, belts, rails, pads, drums, and rollers.

As used herein, a drive member or wiper member may be powered by any suitable mechanical, electrical, electromechanical, magnetic, pneumatic, hydraulic, or other such means. In one such example, a continuous belt (e.g., drive belt or wiper belt) may be powered by a motor-driven pulley arrangement.

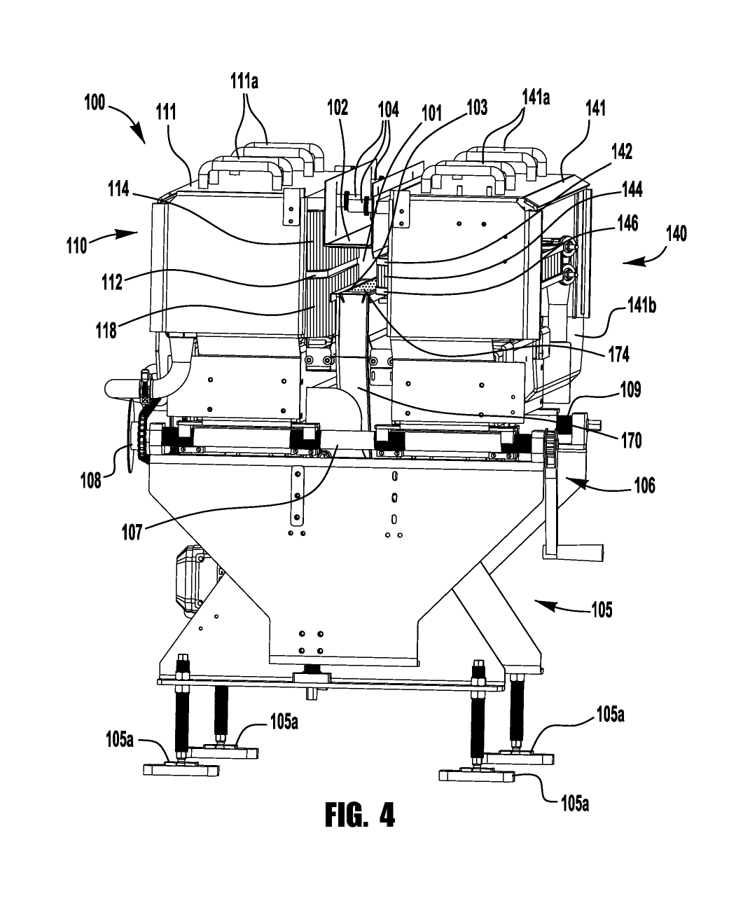

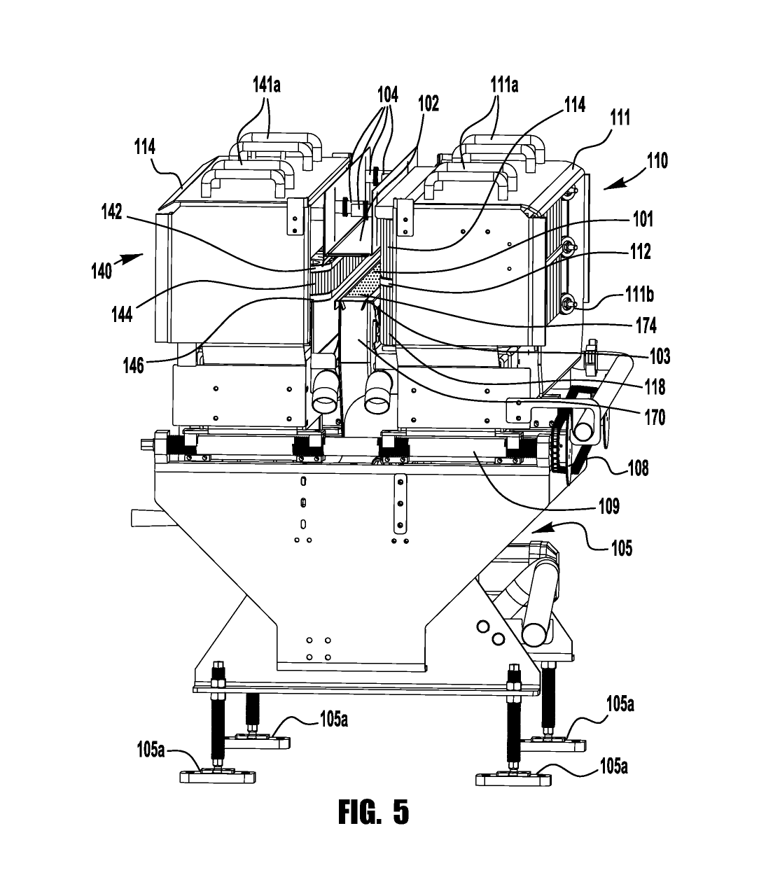

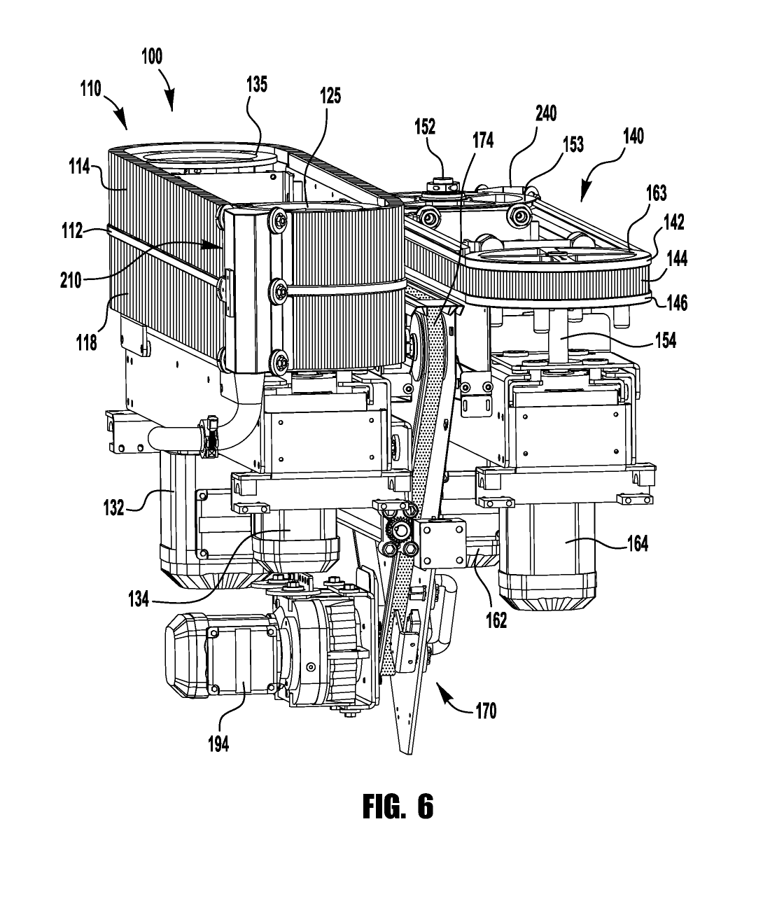

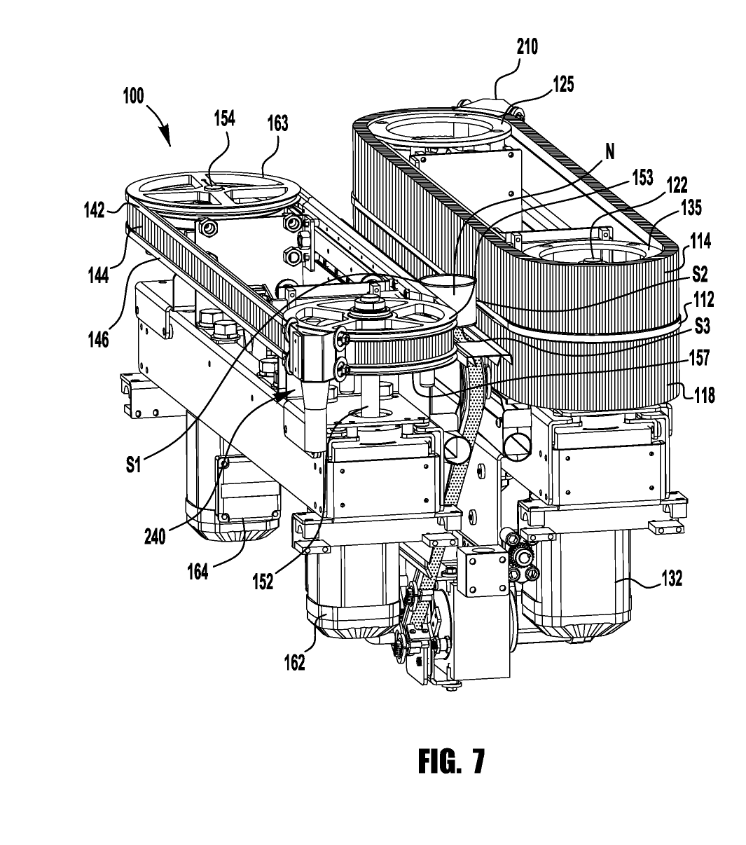

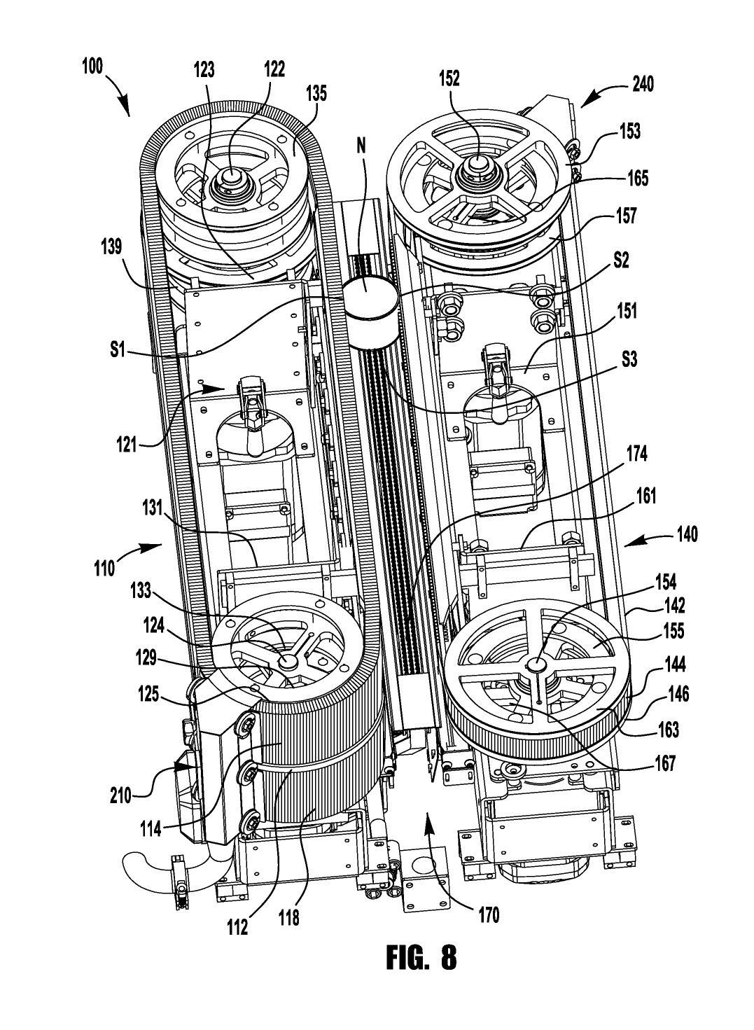

In an exemplary embodiment of the present application, a cleaning apparatus includes one or more drive belts for imparting forward motive forces and forward rotational forces on an article conveyed to the apparatus, and one or more wiper belts for imparting wiping forces on the article and against one or both of the forward motive forces and forward rotational forces. FIGS. 4-13 illustrate various views of an exemplary cleaning apparatus 100 including first and second side assemblies 110, 140 defining a passage 101 through which one or more articles (e.g., a can N, as shown in FIGS. 7 and 8) may be conveyed for cleaning. The passage 101 is defined in part by upper and lower guide plates 102, 103 that support and position the articles N as it is conveyed through the passage. The position of the guide plates 102, 103 may be adjustable (for example, by fasteners 104), for example, to vary the size of the passage to permit conveyance of different sized articles N.

A cleaning apparatus may be supported or otherwise position using a variety of suitable structures. In the illustrated embodiment, the exemplary cleaning apparatus 100 includes a support frame 105 with adjustable support feet 105a configured to elevate the apparatus for alignment with other stations in an automated processing line. Covers 111, 141 may optionally be provided with the first and second side assemblies 110, 140 to protect the belts and other internal components and to protect users from inadvertent contact with the moving belts, while still permitting easy access to these components for maintenance or other adjustments. The covers 111, 141 may optionally be fitted to the side assemblies for sliding engagement, with handles 111a, 141a facilitating removal of the covers. The covers may include windows or clear panels 111b, 141b to allow for observation of the internal components while the covers remain installed. Additionally, the apparatus frame may be provided with electromechanical or electromagnetic sensors or switches configured to disable the apparatus when a cover is removed from the side assembly.

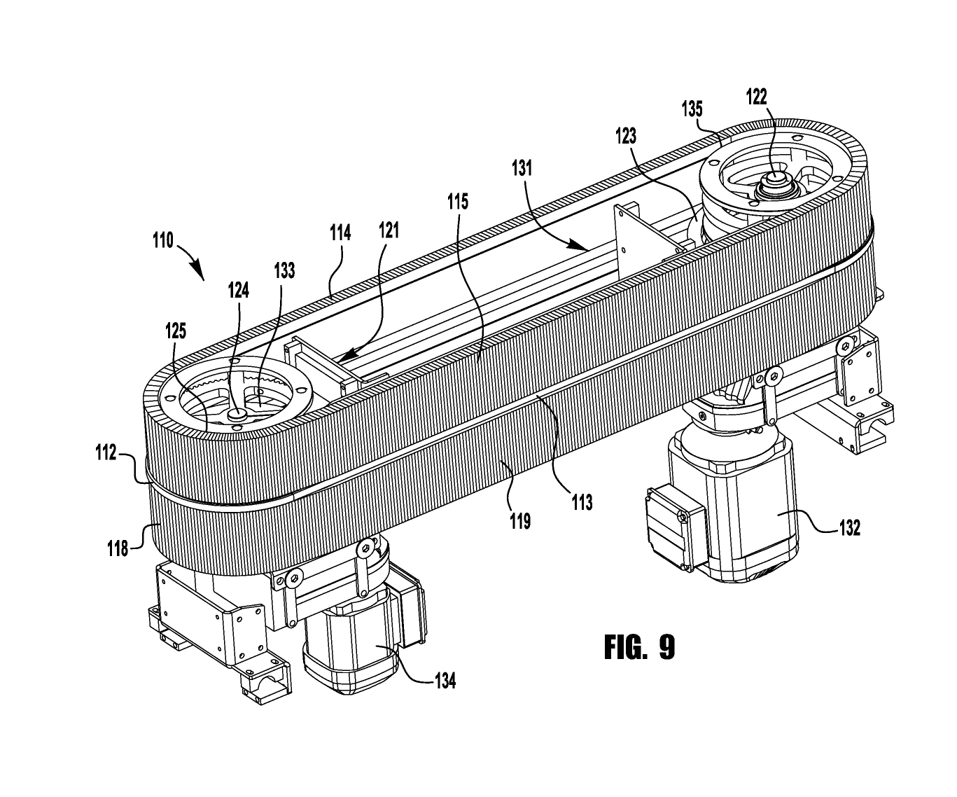

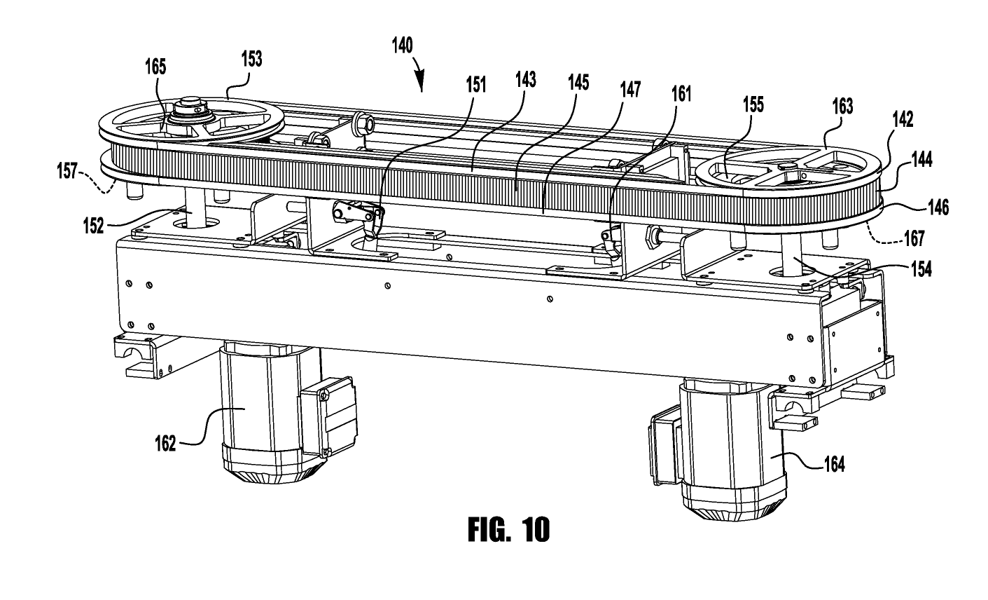

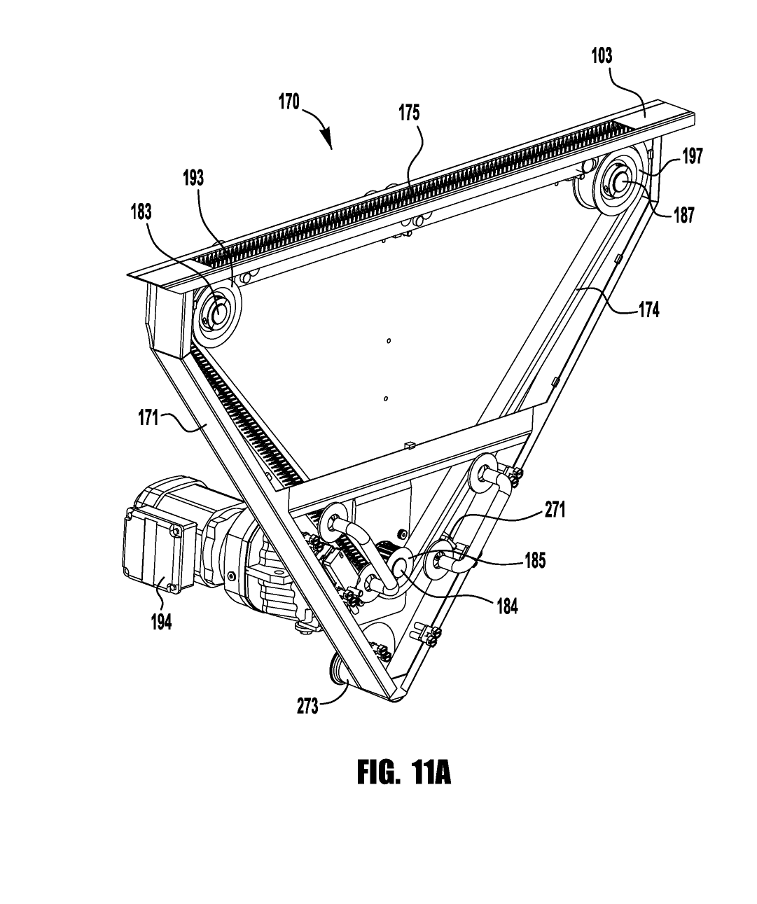

The sides of an article receiving passage in a cleaning apparatus may be defined by one or more drive belts and one or more wiper belts, as described above. In the illustrated example, the first side assembly 110 includes a first drive belt 112 interposed between first and second wiper belts 114, 118, with a first article engaging surface 113 (FIGS. 7 and 9) of the first drive belt 112 being substantially coplanar with first and second article wiping surfaces 115, 119 of the first and second wiper belts 114, 118. The second side assembly 140 optionally includes a third wiper belt 144 interposed between second and third drive belts 142, 146 with a third article wiping surface 145 (FIGS. 8 and 10) of the third wiper belt 144 being substantially coplanar with second and third article engaging surfaces 143, 147 of the second and third drive belts 142, 146. The third wiper belt 144 may be positioned to align with the first drive belt 112 of the first side assembly 110, for wiping engagement of a portion of the article N (e.g., a center portion) that is not wiped by the first and second wiper belts 114, 118. The article engaging surfaces 113, 143, 147 and article wiping surfaces 115, 119, 145 together define the sides of the passage 101 and are positioned to closely receive, contact, or engage the conveyed article N. The positions of the side assemblies 110, 140 with respect to each other may optionally be adjustable to increase or reduce the space between the sides of the passage, for example, to accommodate articles N of varying sizes. In the illustrated example, the apparatus 100 includes a manually operated crank assembly 106 (FIG. 4) configured to drive a first threaded positioning rod 107 to spread apart or draw together inlet ends of the side assemblies 110, 140. The first positioning rod 107 is connected by a chain linkage mechanism 108 to a second threaded positioning rod 109 for simultaneous adjustment of outlet ends of the side assemblies 110, 140.

The drive belts 112, 142, 146 and wiper belts 114, 118, 144 may be powered by any suitable configuration. In the illustrated example, the first and second side assemblies 110, 140 include motor driven pulleys that power the drive belts and wiper belts. Other configurations for powering the belts may occur to those skilled in the art may additionally or alternatively be employed. In the first side assembly 110, as shown in FIGS. 8 and 9, a first drive shaft 122 is powered by a first motor 132 to rotate a first drive pulley 123 in driving engagement with the first drive belt 112, and a second drive shaft 124 is powered by a second motor 134 to rotate second and third drive pulleys 125, 129 in driving engagement with the first and second wiper belts 114, 118. A first non-driven pulley 133 is disposed on the second drive shaft 124 to guide movement of the first drive belt 112, and second and third non-driven pulleys 135, 139 are disposed on the first drive shaft 122 to guide movement of the first and second wiper belts 114, 118. Belt tensioning mechanisms 121, 131 may optionally be provided on the first side assembly 110 to move the motors 132, 134 and drive shafts 122, 124 for proper tensioning of the belts 112, 114, 118.

In the second side assembly 140, as shown in FIGS. 8 and 10, a third drive shaft 152 is powered by a third motor 162 to rotate fourth and fifth drive pulleys 153, 157 in driving engagement with the second and third drive belts 142, 146, and a fourth drive shaft 154 is powered by a fourth motor 164 to rotate a sixth drive pulley 155 in driving engagement with the third wiper belt 144. Fourth and fifth non-driven pulleys 163, 167 are disposed on the fourth drive shaft 154 to guide movement of the second and third drive belts 142, 146, and a sixth non-driven pulley 165 is disposed on the third drive shaft 152 to guide movement of the third wiper belt 144. Belt tensioning mechanisms 151, 161 may be provided on the second side assembly 140 to move the motors 162, 164 and drive shafts 152, 154 for proper tensioning of the belts 142, 144, 146.

Wiper members for an article cleaning apparatus (e.g., the wiper belts 114, 118, 144, 174 of the cleaning apparatus of FIGS. 4-13) may include a wide variety of materials suitable for rubbing, wiping, agitating or otherwise engaging an article to be cleaned. Example materials include urethane, silicone, Aflas, Buna-N, Butyl, ECH, EPDM, EVA, Gum, Hypalon, lonomer, Latex, Neoprene, Polyethylene, Polyimide, TPFE, Teflon, Santoprene, SBR, Vinyl, Viton, Kevlar, fluorosilicone, polypropylene, natural or synthetic rubber, Styrofoam, any form of rubber, plastic, or foam, synthetic bristle brushes, natural bristle brushes (such as horsehair), or metal wire brushes. The wiper material may also include scouring (scotch-brite) pads, cheese cloth, cloth impregnated with a tacky adhesive, plain cloth, etc. The wiper member may be provided in a single material (e.g., as a one-piece component), or with wiping elements in a material selected to provide suitable wiping engagement with the articles carried by another component or portion (e.g., a belt, plate, rail, roller, etc.) provided in a different material (e.g., a material selected to provide durability, rigidity, or reduced cost). In one such embodiment, portions of the wiper member that contact the articles are limited to elastomeric materials (e.g., urethane, silicone, polypropylene, and synthetic rubber) that provide flexible wiping engagement with the articles to be cleaned. For elastomeric or rubbery materials, the hardness (Durometer) can range from very soft to very hard. The composition of the materials can vary within the structure (e.g. dual durometer material with hard plastic base and soft wiping elements). Preferably, the wiper members are made from one or more materials that are flexible enough to bend when passing over the article surface, to conform with the outer surface of the article and increase surface contact.

Wiping elements on a wiper member may include one or more of many different shapes or structures, including, for example, nubs, cleats, fingers, nipples, cups, depressions, bosses, extrusions, ribs, holes, channels, or slots. These elements may be presented, for example, in repeating or random sequences. The wiper members may optionally be provided with holes or channels through which dust and debris can be vacuumed or blown with compressed air. The wiping elements may include different end shapes (e.g., flat, rounded, pointed, beveled, chamfered, cupped, flared, stepped, crowned, etc.). The wiper members may, for example, be formulated with anti-static material or other coating material to assist with the removal of dust and debris or to otherwise prevent powder from sticking to the wiper belts too readily. The wiper members may be formulated with an additive to attract dust or debris to facilitate removal from containers. The wiper member may be provided in the form of belts, pads, sheets, or plates, for example, wrapped around or inside a drum, cylinders, or spheres.

Wiping elements may be provided with varying lengths within the same structure (e.g., staggered fingers—short-tall-short-tall). The wiping elements may be angled (e.g., laid-back fingers). A combination of straight and angled wiping elements may be employed together (e.g., fingers alternating—angle-straight-angled-straight). The wiping elements may be provided in a range of sizes, lengths, or girths. The wiping elements may be provided in one or more of any suitable shape (circular profile, square profile, fins, triangular, and so-on).

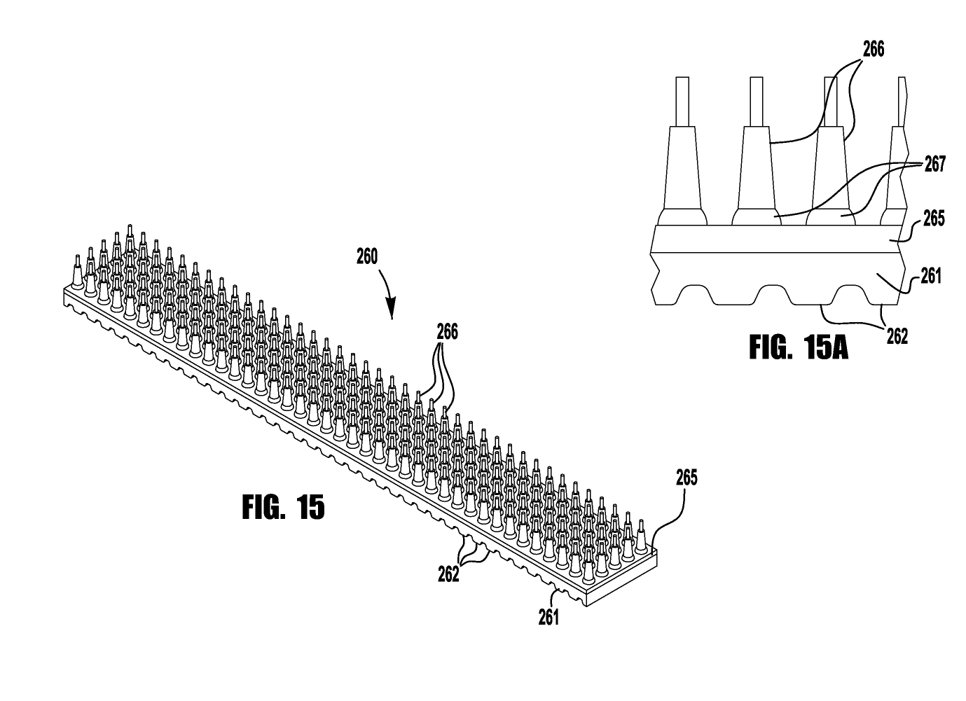

Wiper belts may be formed in a variety of suitable configurations. In one embodiment, the wiper belt includes an inner, gear driven belt portion and an outer, wiper element carrying belt portion. In one example, the inner belt portion may be provided in a more durable material (e.g., urethane, natural rubber, Neoprene, nylon or other suitable belting, which may be reinforced, for example, with Kevlar, steel, aramid, fiberglass, or other suitable reinforcement) to withstand extended driven engagement with a gear driving mechanism, and the outer belt material may be provided in a more flexible material (e.g., FDA cast urethane, with a durometer of 50-65, or approximately 55) to facilitate effective wiping of the articles to be cleaned). The inner and outer belt portions may be cast together to ensure proper adhesion, or may be otherwise adhered together after manufacturing, such as by the use of an adhesive or fastener. In exemplary embodiments, as shown in FIGS. 14, 14A, 15, and 15A, a wiper member 250, 260 includes an inner belt portion 251, 261 having a series of teeth 252, 262 for engaging pulleys for suitable driven and guided engagement with the pulleys, and the outer belt portion 255, 265 includes a plurality of projections 256, 266 extending from an external surface to effect wiping engagement with the articles being cleaned. While the projections may be adhered, fastened, or otherwise attached to the outer belt portion, in the illustrated exemplary embodiments, the projections 256, 266 are integrally formed with the outer belt portion 255, 265. This integral arrangement may reduce the likelihood that a projection may become detached from the belt and contaminate one or more of the articles being cleaned. The outer belt portion with integral projections may be formed, for example, by casting, injection molding, extrusion, or any other suitable process.

To provide sufficient wiping action, the projections 256, 266 may be sufficiently long and sufficiently thin to provide a gentle wiping action against the moving articles N. In one such example, elongated fin-shaped projections 255 (as shown in FIGS. 14 and 14A) extend from the outer belt portion 255 a distance of approximately 0.75 inches (or more than 3.5 times the nominal belt thickness, excluding the projections, of approximately 0.21 inches), with an end thickness of approximately 0.05 inches (or less than ¼ times the nominal belt thickness). As shown, the projections 256 may be thicker at the root 257 (e.g., approximately 0.14 inches, or about ⅔ the nominal belt thickness) to provide for more robust retention on the belt, reducing the likelihood of breakage or detachment. In another example, elongated finger-shaped projections 266 (as shown in FIGS. 15 and 15A) extend from the outer belt portion a distance of approximately 0.75 inches (or approximately 3.5 times the nominal belt thickness, excluding the projections, of approximately 0.21 inches), with an end thickness of approximately 0.063 inches (or less than ⅓ times the nominal belt thickness). As shown, the projections 266 may be thicker at the root 267 (e.g., approximately 0.19 inches, or about equal to the nominal belt thickness) to provide for more robust retention on the belt, reducing the likelihood of breakage or detachment. In the illustrated example, the first, second, and third wiper belts 114, 118, 144 are provided with the wide, fin-shaped projections 256 shown in FIGS. 14 and 14A, which have been shown to effectively wipe a relatively uniform cylindrical surface. For non-uniform surfaces (such as the recessed article end surface, described in greater detail below), narrower flexible projections (for example, the finger-shaped projections shown in FIGS. 15 and 15A) that flex side-to-side may provide for improved wiping of recessed or angled surfaces on the article.

In an exemplary cleaning operation using the illustrated cleaning apparatus 100, to provide for forward rotation and forward movement of the conveyed article N, the first drive belt 112 may be powered to move the first article engaging surface 113 in a forward direction to impart a forward motive force and a forward rotational force on the article N. To increase the net forward motive force (and the resulting velocity of the article N through the passage 101), while maintaining a net forward (albeit reduced) rotational force on the article N, the second and third drive belts 142, 146 may be powered to move the second and third article engaging surfaces 143, 147 in a forward direction at a slower speed than the forward movement of the first article engaging surface 113. To increase the net forward rotational force (and the resulting rotational velocity of the article N), while maintaining a net forward (albeit reduced) motive force on the article N, the second and third drive belts 142, 146 may be powered to move the second and third article engaging surfaces 143 in a rearward direction at a slower speed than the forward movement of the first article engaging surface 113. In an exemplary implementation of the illustrated apparatus 100, velocity and direction of movement of the drive belts 112, 142, 146 may be adjusted to provide the desired net forward motive and rotational forces on the conveyed articles N. In an exemplary cleaning process, the velocity and direction of movement of the drive belts are adjusted such that the article experiences at least one full rotation while the article is in contact with the wiper belts, to ensure that the entire circumferential surface of the article is engaged by the wiper belts as the article passes through the cleaning apparatus. In other embodiments, the article may rotate more than one full rotation (e.g., at least two rotations or more than two rotations). Similarly, the velocity and direction of movement of the drive belts may be adjusted such that the article experiences at least a predetermined multiple number of full rotations (e.g., two or more full rotations) while the article is in contact with the wiper belts for increased cleaning of the entire circumference of the article.

To provide for wiping of the conveyed article N opposite or against the movement of the contacted surface of the article, the first and second wiper belts 114, 118 may be powered to move the first and second article wiping surfaces 115, 119 in a rearward direction, against forward translational and forward rotational movement of a first contacted surface 51 of the article N. Where the forward rotational and forward translational movement of the conveyed article N results in a net forward movement of a second contacted surface S2 of the article (e.g., where translational velocity of the article is high and rotational velocity is low), the third wiper belt 144 may be powered to move the third article wiping surface 145 in a rearward direction, against the net forward movement of the second contacted surface S2. Where the forward rotational and forward translational movement of the conveyed article N results in a net rearward movement of the second contacted surface S2 of the article (e.g., wherein translational velocity of the article is low and rotational velocity is high), the third wiper belt 144 may be powered to move the third article wiping surface 145 in a forward direction, against the net rearward movement of the second contacted surface S2.

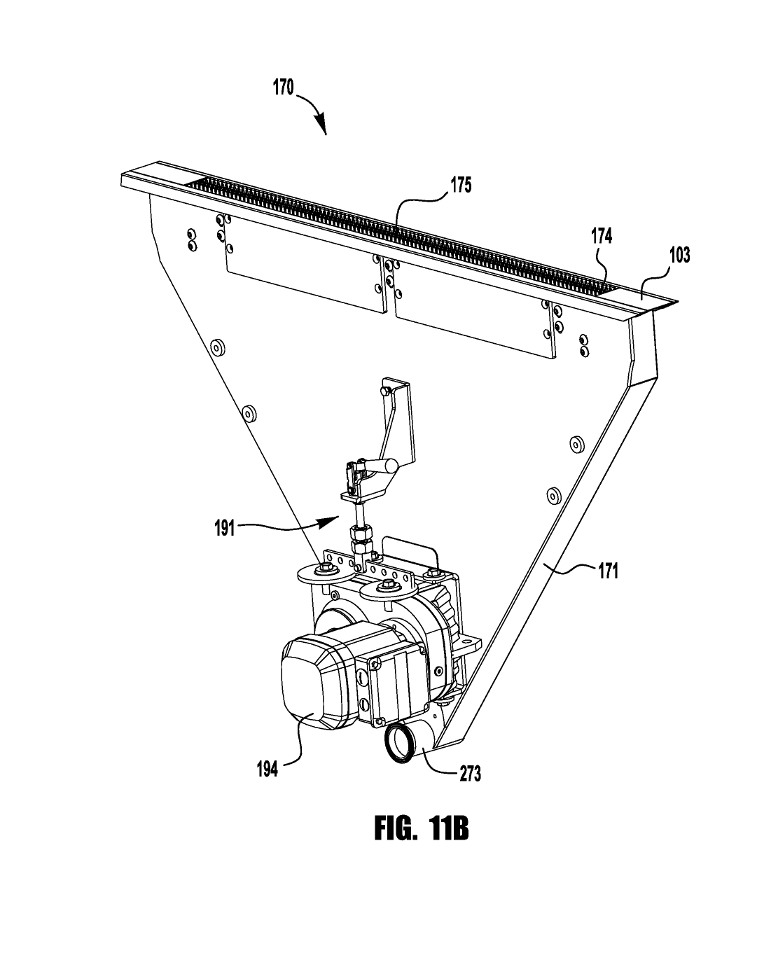

To clean surfaces of an article that extend transverse to drive member (e.g., drive belt) engaging surfaces, wiper members (e.g., wiper belts) may additionally or alternatively be configured to include article wiping surfaces that extend transverse to the article engaging surfaces of the drive belts and that are positioned to impart a wiping force on the transverse surface of the article. In the illustrated example, the cleaning apparatus 100 is provided with a lower assembly 170 extending between the first and second side assemblies 110, 140. The lower assembly 170, as shown in FIGS. 11A and 11B, includes a fourth wiper belt 174 defining a fourth article wiping surface 175 along an upper end of the lower assembly at least partially defining a bottom surface of the passage 101. In the lower assembly, a fifth drive shaft 184 is powered by a fifth motor 194 to rotate a fifth drive pulley 185 in driving engagement with the fourth wiper belt 174. Seventh and eighth non-driven pulleys 193, 197 are disposed on idle shafts 183, 187 to form the fourth wiper belt 174 in a substantially triangular shape and to guide movement of the fourth wiper belt 174. A belt tensioning mechanism 191 may optionally be provided on the lower assembly 170 to move the motor 194 and drive shaft 184 for proper tensioning of the wiper belt 174.

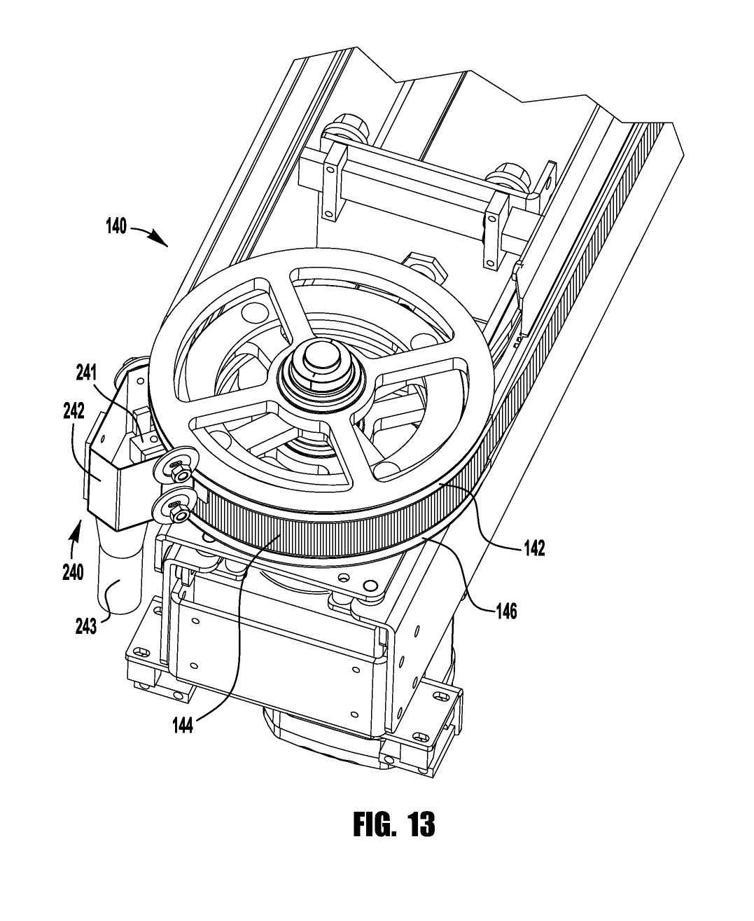

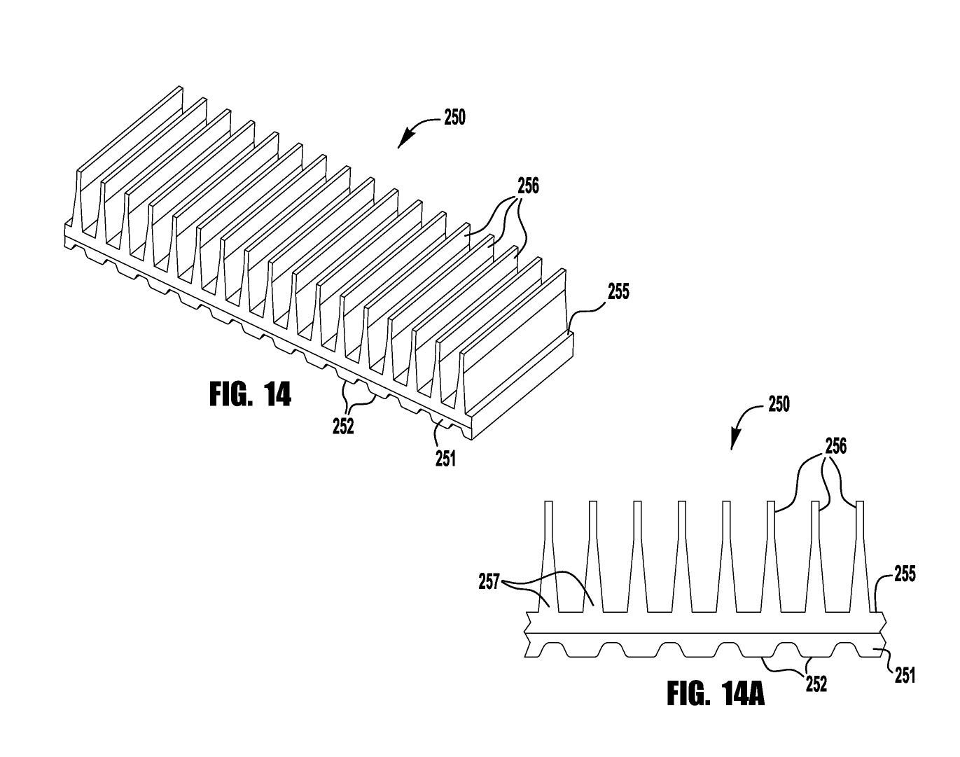

To provide for wiping of the contacted transverse surface S3 of the conveyed article N opposite or against the forward movement of the transverse surface S3, the fourth wiper belt 174 may be powered to move the fourth article wiping surface 175 in a rearward direction, against forward translational movement of the transverse surface S3. While the fourth wiper belt 174 may be wide enough to extend across the entire transverse surface S3, when the article N is rotated as it is conveyed through the apparatus (by the drive belts, as described above, or by some other method), a wiper belt 174 that is narrower than the transverse surface S3 may be used to clean the entire transverse surface. Further, where the article N has a non-uniform end surface S3 (e.g., a can end with a raised rim), the wiper belt may be provided with narrower wiping projections (e.g., the finger-shaped projections 266 of FIGS. 13 and 13A) that bend or flex side-to-side for increased wiping engagement with the transverse surface S3. The transverse wiper belt 174 may perform additional processing or finishing functions to the article. For example, where the article N is a canister or other container with a removable film or foil top, the transverse wiper belt 174 may effectively flatten down the foil top, including, for example, any bent or raised removal tabs.

In operation, a wiper member may accumulate powder, dirt, and other contaminants that are removed from the cleaned articles and/or that settle onto the wiper member from the environment. Without periodic removal of such accumulated material from the wiper member, the wiper member may deposit some of these accumulated contaminants on the articles that the wiper member is intended to clean. According to an aspect of the present application, a cleaning apparatus may be configured such that an article wiping surface of the wiper member separates from the conveyed articles over a sufficient space and time during normal operation of the cleaning apparatus to permit performance of a wiper cleaning operation on the separated portion of the article wiping surface without shutting down the cleaning apparatus to clean the wiper member.

In an exemplary embodiment, a cleaning apparatus utilizing a continuous wiper belt includes a wiper cleaning assembly that cleans a return surface of the wiper belt, spaced apart from the article wiping surface and out of contact with the article, allowing the cleaning apparatus to remain in operation while the wiper belt is continuously cleaned, and minimizing or preventing re-contamination of the articles. Many different suitable cleaning assemblies may be utilized to clean the return side of the wiper belt, including, for example, one or more of a vacuum arrangement, a cleaning fluid (e.g., compressed gas, water, alcohol etc.) dispenser, and a belt agitating mechanism (e.g., ultrasonic treatment, vibration, beater bars, etc.). Other exemplary mechanisms involve ionization, steam, plasma treatment, and sterilization (e.g., UV light bombardment, peroxide treatment, high-temperature steam, alcohol, or ozone). In one such example, a cleaning apparatus is provided with a wiper belt cleaning assembly including an air knife configured to focus high pressure air on a return surface of a wiper belt to disperse powder and other contaminants from the return surface. The air knife may optionally discharge ionized air to facilitate cleaning. The wiper belt cleaning assembly may additionally include a vacuum mechanism configured to remove the dispersed contaminants from the apparatus.

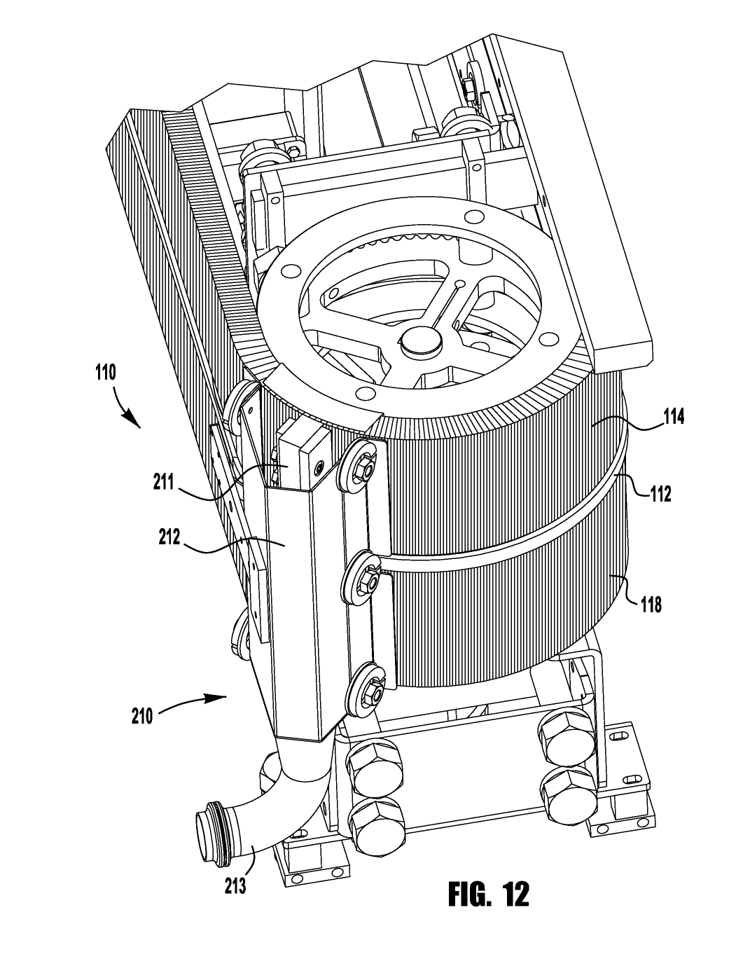

In the illustrated embodiment of FIGS. 4-13, the first side assembly 110 is provided with a first wiper cleaning assembly 210 including an air knife 211 (FIG. 12) surrounded by a vacuum plenum 212 connected with vacuum tubing 213 supported by the apparatus frame 105. The first wiper cleaning assembly 210 may be secured to the first side assembly 110 (e.g., by fasteners) in close proximity with return surfaces of the first and second wiper belts 114, 118, such that the air knife 211 is proximate to or even in contact with the projections 256 on the moving wiper belts 114, 118, such that the focused pressurized air discharged by the air knife 211 effectively removes powder, dust, and other contaminants accumulated on the wiper belts. Upon separation from the wiper belts 114, 118, these contaminants are removed from the surrounding vacuum plenum 212 by suction applied to the vacuum tubing 213. While the first wiper cleaning assembly 210 may be secured at any location along a return surface of the wiper belts 114, 118 (i.e., locations where the wiper belts are not engaged by the articles to be cleaned), in the illustrated embodiment, the first wiper cleaning assembly 210 is secured at a location proximate to the apparatus inlet, where the rearward directed wiper belts initially diverge from the passage 101.

Similarly, the second side assembly 140 is provided with a second wiper cleaning assembly 240 including an air knife 241 (FIG. 13) surrounded by a vacuum plenum 242 connected with vacuum tubing 243 supported by the apparatus frame 105. The second wiper cleaning assembly 240 may be secured to the second side assembly 140 in close proximity with the return surface of the third wiper belt 144 such that the air knife 241 is proximate to or even in contact with the projections 256 on the moving wiper belt 144, such that the focused pressurized air discharged by the air knife 241 effectively removes powder, dust, and other contaminants accumulated on the wiper belt and/or wiping elements. Upon separation from the wiper belt 144, these contaminants are removed from the surrounding vacuum plenum 242 by suction applied to the vacuum tubing 243. While the second wiper cleaning assembly 240 may be secured at any location along a return surface of the wiper belt 144 (i.e., locations where the wiper belt is not engaged by the articles to be cleaned), in the illustrated embodiment, the second wiper cleaning assembly 240 is secured at a location proximate to the apparatus outlet, where the forward directed wiper belt initially diverges from the passage 101.

The lower assembly 170 may likewise be provided with a wiper cleaning assembly. In the illustrated embodiment, as shown in FIG. 11A, an air knife 271 is secured within the lower assembly housing 171 in close proximity with the return surface of the fourth wiper belt 174 such that the air knife 271 is proximate to or even in contact with the projections 266 on the moving wiper belt 174, such that the focused pressurized air discharged by the air knife 271 effectively removes powder, dust, and other contaminants accumulated on the wiper belt 174 and/or wiping elements. Upon separation from the wiper belt 174, these contaminants are removed from the surrounding housing 171 (which functions as a vacuum plenum) by suction applied to vacuum tubing 273. While the air knife 271 may be secured at any location along a return surface of the wiper belt 174 (i.e., locations where the wiper belt is not engaged by the articles to be cleaned), in the illustrated embodiment, the air knife 271 is secured at a location proximate to the vacuum tubing 273, for example, to facilitate suction of the released contaminants within the housing 171.

In an exemplary can cleaning process utilizing the exemplary article cleaning apparatus 100 of FIGS. 4-13, a can (or other cylindrical container) is conveyed into the passage 101 of the cleaning apparatus 100. The first drive belt 112 on the first side of the passage 101 is powered (by motor-driven pulley 123) such that the article engaging surface 113 on first drive belt moves forward to impart a forward motive force and a forward rotational force on a cylindrical side wall of the can N. The second and third drive belts 142, 146 on the second side of the passage are powered (by motor-driven pulleys 153, 157) such that article engaging surfaces 143, 147 on the second and third drive belts move rearward to impart a rearward motive force (less than the forward motive force imparted by the first drive belt 112) and a forward rotational force on the side wall of the can N. The first and second wiper belts 114, 118 on the first side of the passage 101 are powered (by motor-driven pulleys 125, 129) such that the article wiping surfaces 115, 119 on the first and second wiper belts move rearward to impart a rearward wiping force on the side wall of the can N, against forward rotational and forward translational movement of the can. The third wiper belt 144 on the second side of the passage 101 is powered (by motor-driven pulley 155) such that the article wiping surface 145 on the third wiper belt moves forward to impart a forward wiping force on the side wall of the can N, against forward rotational movement of the can. The fourth wiper belt 174, below the passage 101, is powered (by motor-driven pulley 185) such that the article wiping surface 175 on the fourth wiper belt moves rearward to impart a rearward wiping force on the end surface of the can N, against the forward translational and forward rotational movement of the can N. The first wiper cleaning assembly 210 discharges pressurized air on the article wiping surfaces 115, 119 of the first and second wiper belts 114, 118 and vacuums away released contaminants after the first and second wiper belts diverge from the passage 101 at the inlet end of the apparatus 100. The second wiper cleaning assembly 240 discharges pressurized air on the article wiping surface 145 on the third wiper belt 144 and vacuums away released contaminants after the third wiper belt diverges from the passage at the outlet end of the apparatus 100. The third wiper cleaning assembly 270 vacuums away contaminants from the third wiper belt 174. The cleaned article wiping surface 115, 119, 155, 175 are returned to the passage 101 by continued movement of the first, second, third and fourth wiper belts 114, 118, 144, 174. The cleaned cans N are moved through the outlet of the passage 101, for example, to another portion of a can processing system (e.g., labeling, packaging).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. An apparatus for cleaning an article, the apparatus comprising:
a first drive belt defining a first article engaging surface extending substantially parallel to a second article engaging surface of the apparatus and positioned to receive the article between the first and second article engaging surfaces, the first drive belt being powered to move in a first direction such that the first article engaging surface imparts a forward motive force on an outer surface of the article; and
a first wiper belt defining a first article wiping surface positioned to contact the article, the first wiper belt being powered to move in a second direction opposite the first direction such that the first article wiping surface imparts a rearward wiping force on the article.

2. The apparatus of claim 1, wherein the first article wiping surface is substantially coplanar with the first article engaging surface.

3. The apparatus of claim 1, wherein the first drive belt is further powered to impart a forward rotational force on the outer surface of the article and against the rearward wiping force of the first article wiping surface.

4. The apparatus of claim 1, further comprising a second drive belt defining the second article engaging surface.

5. The apparatus of claim 4, wherein the second drive belt is powered to move in a third direction such that the second article engaging surface imparts a forward motive force on the side wall of the article.

6. The apparatus of claim 5, wherein the second drive belt is powered to move at a slower rate than the first drive belt, such that the first and second drive belts impart a forward rotational force on the side wall of the article.

7. The apparatus of claim 4, wherein the second drive belt is powered to move in a third direction, such that the second article engaging surface imparts a rearward motive force on the side wall of the article, with the forward motive force being greater than the rearward motive force for forward movement and forward rotation of the article.

8. The apparatus of claim 1, further comprising a second wiper belt defining a second article wiping surface substantially coplanar with the first article wiping surface and spaced apart from the first article wiping surface by the first article engaging surface, and positioned to contact the article, the second wiper belt being powered to move in the second direction such that the second article wiping surface imparts a rearward wiping force on the side wall of the article.

9. The apparatus of claim 1, further comprising a second wiper belt defining a second article wiping surface transverse to the first article wiping surface and positioned to contact an end wall of the article, the second wiper belt being powered to move in a third direction such that the second article wiping surface imparts a rearward wiping force on the end wall of the article.

10. The apparatus of claim 1, wherein the first wiper belt includes a plurality of flexible projections sized and positioned to impart the rearward wiping force on the side wall of the article.

11. The apparatus of claim 10, wherein the plurality of flexible projections comprise laterally extending ribs.

12. The apparatus of claim 10, wherein the plurality of flexible projections are formed with the first wiper belt as an integral elastomeric component.

13. The apparatus of claim 10, wherein each of the plurality of flexible projections extends from the first wiper belt a distance at least three times a nominal thickness of the first wiper belt.

14. The apparatus of claim 10, wherein each of the plurality of flexible projections includes a root thickness that is greater than a nominal thickness of the first wiper belt.

15. The apparatus of claim 1, wherein the first wiper belt comprises a continuous belt further defining a return surface spaced apart from the first article wiping surface and out of contact with the article, the apparatus further comprising a wiper cleaning assembly operable to remove contaminants from the return surface.

16. The apparatus of claim 15, wherein the wiper cleaning assembly comprises at least one of a vacuum assembly, a cleaning fluid dispenser, and a belt agitating mechanism.

17. The apparatus of claim 15, wherein the wiper cleaning assembly includes an air knife disposed within a vacuum plenum, the vacuum plenum being secured over a portion of the first wiper belt.

18. The apparatus of claim 17, wherein the first wiper belt includes a plurality of flexible projections sized and positioned to impart the rearward wiping force on the side wall of the article, the air knife being positioned to contact the plurality of flexible projections when the wiper belt is powered to move in the second direction.

19. An apparatus for cleaning an article, the apparatus comprising:
a drive member configured to impart a forward motive force on the article; and
a first wiper belt defining a first article wiping surface, the first wiper belt including a plurality of flexible projections formed with the first wiper belt as an integral elastomeric component, the plurality of flexible projections being sized and positioned to impart a wiping force on the article when the first wiper belt is moved with respect to the article;
wherein the first wiper belt is powered to move the first article wiping surface to impart a rearward wiping force on the article.

20. The apparatus of claim 19, wherein the drive member is configured to impart a forward rotational force on the article.

21. (canceled)

22. The apparatus of claim 19, wherein the plurality of flexible projections comprises laterally extending fins.

23. The apparatus of claim 19, wherein each of the plurality of flexible projections extends from the first wiper belt a distance at least three times a nominal thickness of the first wiper belt.

24. The apparatus of claim 19, wherein each of the plurality of flexible projections includes a root thickness that is greater than a nominal thickness of the first wiper belt.

25. A method for cleaning an article, the method comprising:
receiving the article between first and second opposed article engaging surfaces;
moving at least the first article engaging surface to impart a forward motive force on a side wall of the article;
contacting the article with a first article wiping surface, the first article wiping surface being disposed on a first wiper belt; and
moving the first wiper belt such that the first article wiping surface imparts a rearward wiping force on the article.

26. The method of claim 25, further comprising moving the first article engaging surface forward with respect to the second article engaging surface to impart a forward rotational force on the side wall of the article.

27. The method of claim 26, wherein moving the first article engaging surface forward with respect to the second article engaging surface comprises moving the first article engaging surface in a forward direction and moving the second article engaging surface in a rearward direction.

28. The method of claim 26, wherein moving the first article engaging surface forward with respect to the second article engaging surface comprises moving the first article engaging surface in a forward direction at a first velocity and moving the second article engaging surface in the forward direction at a second velocity, the first velocity being greater than the second velocity.

29. The method of claim 25, further comprising moving the second article engaging surface to impart a rearward motive force on the side wall of the article, with the forward motive force being greater than the rearward motive force for forward movement and forward rotation of the article.
